(19) United States
(12) Patent Application Publication
(10) Pub. No.: US 2012/0318100 A1
(43) Pub. Date: Dec. 20, 2012

(54) Ultra pleat

(76) Inventor: Michael Vincent Latino, Salida, CA (US)

(21) Appl. No.: 13/066,063

(22) Filed: Jun. 15, 2011

(51) Int. Cl. H01M 4/72; F16H 37/06; B21J 13/02

(52) U.S. Cl. 74/665 A; 429/233; 29/2

(57) ABSTRACT

The undersigned inventor propounds through the instrumentality of application Ser. No. 13/066,063, a component of enthalpy expansion of secondary cells through the instrumentality of centerline compliant (orthographic projection, top view) and battery plate/grid uniform pitch standard compliant, pleated battery plates/grids, without deviation of said character, of generic essence, and plate/grid peak to trough alignment during assembly of the cell elements, without deviation, to facilitate and expedite the mass production of said secondary cells, for direct applications to pure electric automotive vehicles, and otherwise, as deemed appropriate by competent engineering.

On Mar. 4, 2011, patent attorney, David E. Newhouse, Esq., patent attorney number 24,911, California State Bar number 54217, did a patent search for me (the undersigned) concerning my claimed invention, “Ultra Pleat” (trademark of MVL Corporation) secondary cell battery plate/grid concept schematic. The following claims/allowances were noted: Mr. E. P. Usher, Number 509,270, Patented Nov. 21, 1893—George J. Doundoulakis, U.S. Pat. No. 5,626,989, Date of Patent May 6, 1997—Yoshinari Sasaki, Shimotoku, Murase, Publication Number US 2007/0059603 A1, Publication Date Mar. 15, 2007.

Mr. Usher's storage battery corrugated conducting sheets are of a biplate/bigrid design (which may have a potential difference negation drawback within each biplate structure). In my claimed “Ultra Pleat” design, the secondary cell plates/grids are monoplates/monogrids in nature. Mr. Usher did not claim in his invention that the corrugated conducting sheets should be so placed/secured so that the peaks and troughs are in consistent, consecutive alignment (with each other). I claim in my invention that the peaks and troughs of my “Ultra Pleat” design are to be in consistent, consecutive alignment (with each other)—so that the ion gradients between the negative and positive plates/grids are as uniform as possible. Mr. Usher's storage battery design may have a mucilage contamination drawback.

The undersigned motions that U.S. Pat. No. 5,626,989, Date of Patent, May 6, 1997, inventor George J. Doundoulakis, be vacated because of overbreadth. All automotive, and deep cycle RV batteries, manufactured, or sold, in the United States, are within the domain of the above Patent, §5: “The density of the pleats may vary between a flat sheet (0 pleats/cm) and about 500 pleats/cm . . . ” The battery that came installed in my Dad's new 1953 FORD had flat sheet construction, zero pleats per centimeter. The next battery that was installed in my Dad's 1953 FORD when the car was about seven years old had plates/grids characterized by zero pleats per centimeter. The battery that is installed in my minivan, The NAPA Legend Premium 84, NAPA part number 8425/75, BCI number 7586DT, that was installed on Mar. 23, 2010, has plates/grids that are characterized by zero pleats per centimeter. Authority to vacate U.S. Pat. No. 5,626,989, Date of Patent, May 6, 1997: See Lanzetta et al. v. State of New Jersey, 306 U.S. 451, 458, 59 S. Ct. 618, 621 (1939).
And a statute which either forbids or requires the doing of an act in terms so vague that men of common intelligence must necessarily guess at its meaning and differ as to its application, violates the first essential of due process of law.

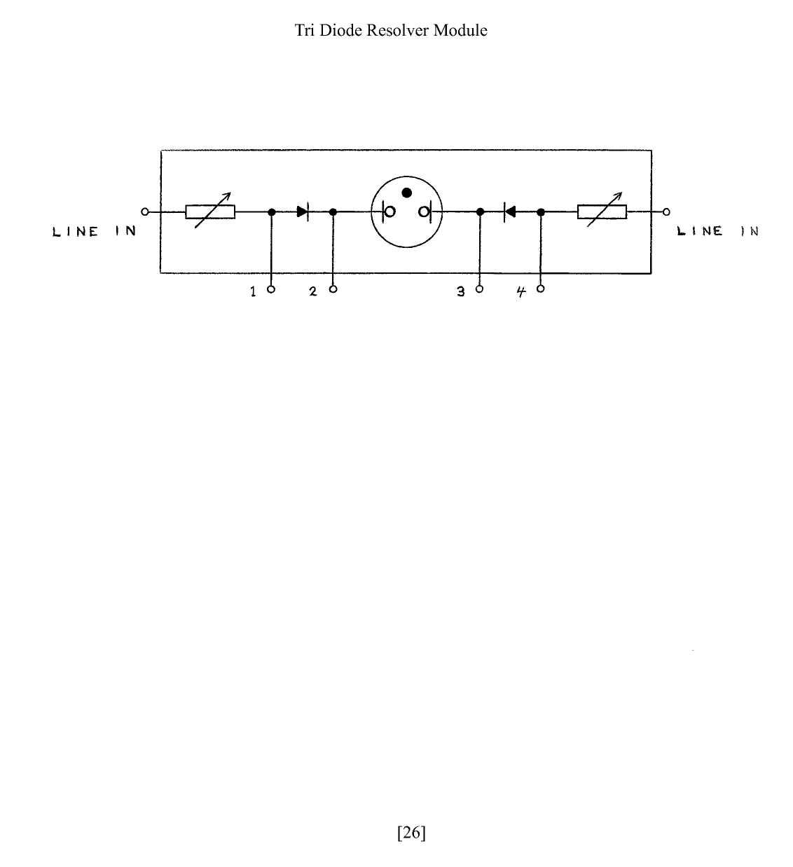

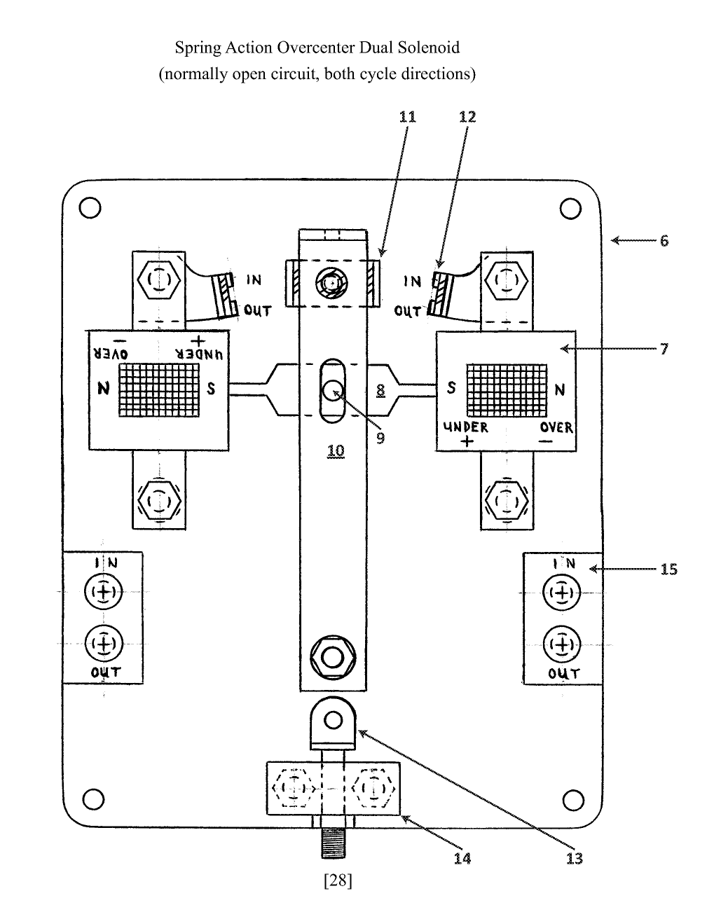

Inventor George J. Doundoulakis did not claim in his invention that pleated (battery) plates should be so placed/secured so that the peaks and troughs are in consistent, consecutive alignment (with each other). See FIG. 7, of U.S. Pat. No. 5,626,989.

I, the undersigned, claim in my invention that the peaks and troughs of my “Ultra Pleat” design are to be in consistent, consecutive alignment (with each other)—so that the ion gradients between the negative and positive plates/grids are as uniform as possible.

United States Patent Application Publication, Publication Number US 2007/0059603 A1, Publication Date Mar. 15, 2007, is a battery plate lug and is a battery plate strap matrix. The battery manufacturer (concerning my invention claims) who would be the licensee, is the entity to determine high kilowatt capacity battery plate/grid lug and plate strap characteristics that will not fail when the secondary cell is subjected to substantial heat of resistance.

I, the undersigned, inventor, claim as my invention, and promulgate said (“Ultra Pleat”) invention, through the instrumentality of employing premachined dies installed in a hydromechanical brake, that establish consistent geometric battery plate/grid contour.

Alternative application of “Vehicle, Electric, Interstate, Alpha”: all systems and components secured directly, or (in part) indirectly, to a steel chassis, and the one, or both, live axles, of the autotrans, 6 speeds, with reverse, fitted with a steel cable spool drum(s), with one end of the steel cable(s) secured to the spool drum(s), and the other end of the steel cable(s) having a secured (to it) weighted steel hook(s), and, when the foundation chassis, of the above mentioned apparatus, is properly and safely secured, weighted, or anchored, at the site of a disaster, it may thus function as an emergency winch or crane. Attach/secure an “A-frame” (to the chassis) and add an additional roller bearing or large ball bearing support (through the instrumentality of the A-frame) to the outer end of each live axle, just beyond the outer end of each cable spool, if winch or crane live axle or spool external deadweight loads, are expected to exceed 1000 pounds (are expected to exceed 454 kilograms) for each of the live axles, or cable spools.

The reason to markedly pleat (the patent sought) secondary cell battery plates/grids is so that the secondary cell unit, for a given, overall outside dimensions, can have the longest duty cycles possible, per a given externally applied electrical load, and per the secondary cell alloys and electrolyte category (starting from a fully charged reference). The “Ultra Pleat” (trademark of MVL Corporation) secondary cell battery plate/grid concept is especially useful for spacecraft and pure electric long range automotive vehicles.

Number of plate/grid openings for the active materials, per square inch of the secondary cell plate/grid, and their specific size of bore: quantitatively tuned for maximum potential difference and maximum duty cycle per an applied external circuit electrical load.

Gauge of grid: conducive to manufacturing feasibility.

Grid swing and pitch: approximately as shown on the MVL Corporation prior art (“Ultra Pleat” secondary cell battery plate/grid concept schematic—top view). Symmetry of the pleats is implied. Number of total pleat cycles per battery plate/grid depends on the duty cycle requirements of the completed secondary cell. Specific dimensions of the pleats per the front view, and per the right side view, depends on the duty cycle requirements of the completed secondary cell. The beginning tab, and the ending tab, of the pleats (per battery plate/grid) may point in opposite directions (as was done on the MVL Corporation prior art). The battery plate/grid pleats, when stretched out in the arithmetic sense, should give a dimension that is at least double the top view linear dimension of a conventional straight (across) plate/grid design (28.125 inches versus 13.5625 inches in the case of the MVL Corporation [original] prior art). Reevaluate the optimum specific gravity of the electrolyte.

Grid alloy and active materials: per the secondary cell type, and per a recharge cycle that is only one quarter of the time of the previous discharge duty cycle time, as the human body, which is an ion/electron generator. Reference: cytochrome oxidase (electron transport chain).

Assembly of “Ultra Pleat” type battery plates: negative and positive plates/grids intermeshed, along with their separators.

Suggest electrolyte and sediment pump suction and evacuation of the electrolyte via drain servicing port, and electrolyte automatic level control refill servicing port, for high performance batteries for spacecraft and pure electric long range automotive vehicles. Also suggest electrolyte gas recovery system (EGRS) that has multiport connections to an accumulator, with dual safety pressure relief valves, that are both set at 1 P.S.I., electrolyte rejective—battery housing and cover must be structural to withstand the differential pressure!

It is imperative that any foundation polymerization catalyst of the ion exchange domain (contains positively or negatively charged sites) or of the electron exchange domain (oxidation—reduction reactions) employs a high performance valence electron character with the counterpart secondary cell plate/grid substratum.

Nickel-cadmium secondary cell: do not use for an electric vehicle project because of its low watt hours per pound and cell imbalance characteristics.

Lead-acid secondary cell: may be tested for an electric vehicle project if it is an “Ultra Pleat” (trademark of MVL Corporation) design (10.5 watt hours per pound at present for a conventional, straight across, plate/grid design). Reevaluate the optimum specific gravity of the electrolyte.

Hydrogen and oxygen fuel cell: do not use for an electric vehicle project because it is too dangerous for high density automotive traffic applications because of its extremely high differential pressure characteristics per the system overall (okay for spacecraft). The trucks that transport high pressure gas cylinders transport said cylinders with the steel protecting caps in place, and such trucks are larger than most of the surrounding traffic. Said transport keeps the high pressure (2,200 pounds per square inch) gas cylinders higher than most of the surrounding traffic. A hydrogen and oxygen (fuel cell) powered automobile, if involved in an accident, would not have such a safety advantage, and the cylinder's valve (fitting) if subjected to structural displacement (because of the accident) could suddenly fly off, becoming a missile, or shrapnel.

The undersigned considers on board vehicle cracking of gasoline, to obtain hydrogen, to be overly dangerous, and said act does not address the ultimate depletion and exhaustion of gasoline supplies. A potential difference ionization event occurring (static electricity discharge), or triboelectric charging precursor event and subsequent ionization event occurring, in the “fuel vaporizer” or “partial oxidation reactor,” in the presence of stoichiometric oxygen, can cause an explosion, due to the precursor of rapid flame propagation and thermal pressure spike, within the “fuel vaporizer” or “partial oxidation reactor,” as these entities are not structural combustion chambers and do not contain a yielding piston or turbine (thermal energy to kinetic energy interface).

Nuclear reactor: is not practical for any electric or steam turbine automotive vehicle because of iffy neutron modulation—also the “Io disposal system” is not operative at this time.

For long range pure electric automotive vehicle project: should use secondary cell zinc (−), silver (+), potassium hydroxide, 35 watt hours per pound, using “Ultra Pleat” (trademark of MVL Corporation) battery plates, or should use secondary cell cadmium (−), silver (+), potassium hydroxide, approximately 35 watt hours per pound, using “Ultra Pleat” (trademark of MVL Corporation) battery plates. Reevaluate the optimum specific gravity of the electrolyte.

Duty cycle requirement of zinc (−), silver (+), or cadmium (−), silver (+), secondary cell, intended for the propulsion circuit of long range pure electric automotive vehicle: 0 to 60 miles per hour, modest acceleration, on the test track, then 60 miles per hour maintained throughout a minimum of 550 miles (continuous vehicular travel).

Approximate character of pure electric automotive vehicle (if a MVL Corporation design): empty weight, when at rest, of approximately 3,000 to 4,000 pounds (one earth gravity). Standard road tires, all four inflated to 32 pounds per square inch (at an assumed temperature of 70 degrees Fahrenheit). Reflex oscillator klystron output waveguide (300 MHz) to a “hybrid grid,” that is placed between the thyratron's control grid and its cathode, for photon emission modulation of the thyratron. Each propulsion motor to be thermocouple, or resistance bulb, equipped, orientation descriptive display (of each motor temperature) directed to the driver. Each induction propulsion motor drives into an overrunning clutch, which in turn drives into a servomechanism transmission/transaxle, six forward speeds, and one (or two) reverse speed(s), and also having accessory drives for a reversible cycle heat pump (gearbox spline driven) and a power steering pump (gearbox spline driven) with one or two hydraulic accumulators for the system, nitrogen precharged. Install inside of the vehicle a high quality, 7 inch, 3 speed fan with (switchable to off) oscillating capability, that has a nonchrome finish. Accelerator pedal to 0 to 120 volts potentiometer. Helicopter linear actuator (adapted to 48 volts direct current) to the cruise control 0 to 120 volts potentiometer. Mode select switch for accelerator pedal potentiometer, or for linear actuator potentiometer—to be within easy reach of a belted in driver. Driver must bring the vehicle's speed to within 3 miles per hour of the cruise control target speed before the cruise control will engage for the purpose of antisurge (even if the driver prematurely cycles the mode select switch to the cruise control position). Antisurge circuit: piggyback resistance looping of both potentiometers, with the resistance loops both connected to a potential difference (current) ebb flow sensing circuit (the Tri Diode Resolver Module)—at a predetermined potential difference—1 volt—the cruise control system may thus engage (within 3 miles per hour of the selected cruise control target speed).

Cruise control droop/over speed: pulsed emf (coming from the vehicle's transmission/transaxle) identification/recognition (by the computer) and the rapidity of the emf pulse events being applied to (modifiable) ratio maintenance coupling with the, and as a proportion of, the (base) intermediate frequency reference (signal)—correction direct current (pulse width modulation) applied to the cruise control linear actuator, per the dictate of the microprocessor (may be analog, digital, or hybrid). Cruise control, change of velocity assignment: driver cycles the linear actuator beep switch. Cruise control knock out: when the brake pedal is depressed 0.250 inch, plus or minus 0.0625 inch. Master cylinder diameter: tune for nonpowered operation (such as a diameter of 0.93750 of an inch). The vehicle(s) must have a clearly labeled master switch with heavy duty contacts, and placed within easy reach of a belted in driver—mandated. Charging electrical prongs for any of the vehicle's secondary cells that are located near the outer surface of the vehicle(s) must be located behind lockable cover door(s) that has/have high quality gasket seal(s), with the lock release mechanism(s) located inside the vehicle(s)—mandated (and of such a design that the lock release can function, or be actuated, even if the vehicle has no electric power—lock release may be on a one minute timer). These covers are to be spring loaded to the fully closed and locked position upon withdrawal of the charging receptacle. It must be realized that large high performance storage batteries, in an instant, can put out more electrical power, than an entire house uses!

Test track (test vehicle) load factor: at least one adult, with a weight of 120 pounds, to 220 pounds, when at apparent rest (at one earth gravity).

Positive charge caused by a deficiency of electrons. Negative charge caused by an excess of electrons.

According to the Federal Aviation Administration, in a circuit, electron flow is from negative, to positive, and within a power source (as a battery), the electron flow is from positive, to negative.

To charge, or recharge a storage battery, the direct current must be passed through it in the opposite direction to that of its discharge.

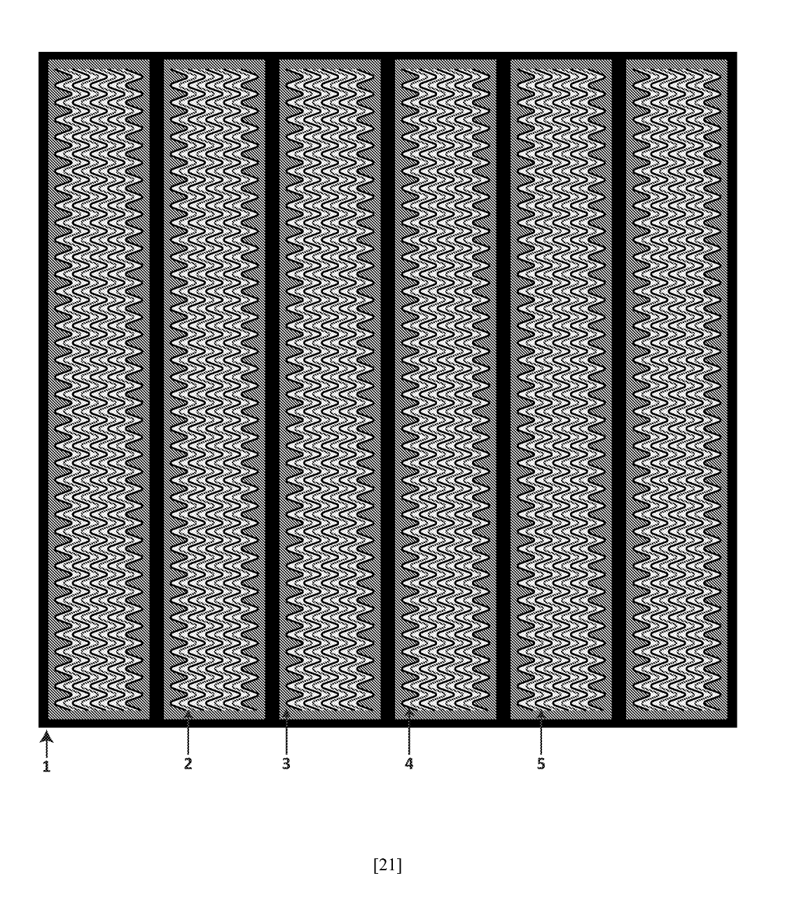

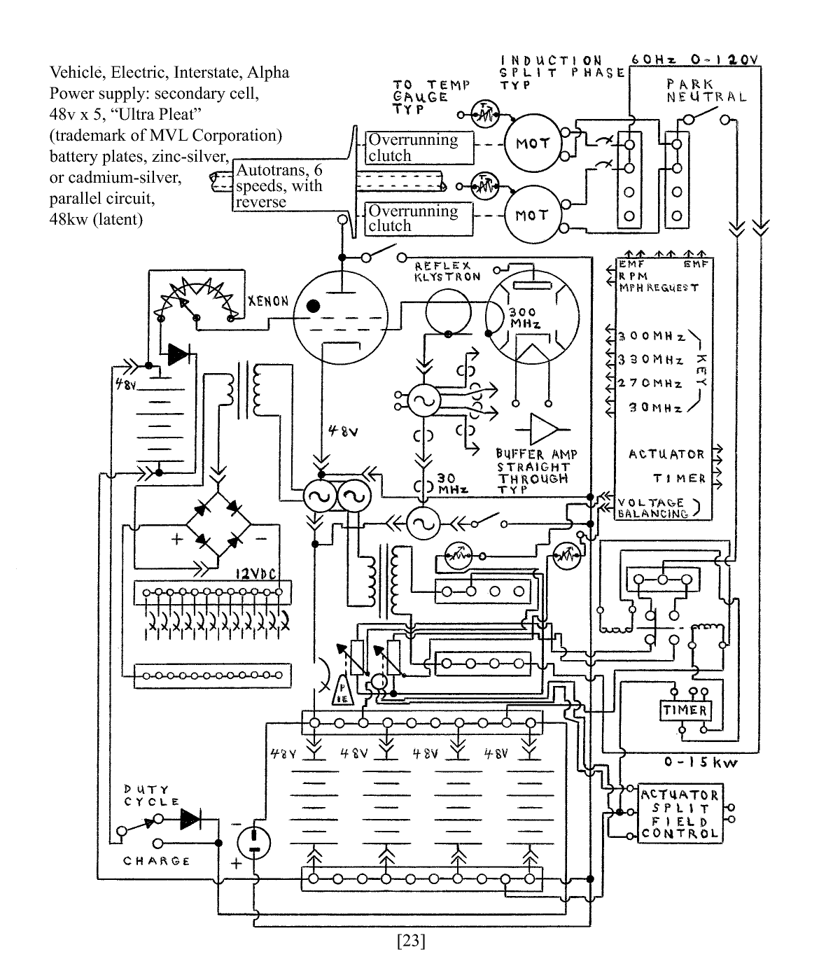

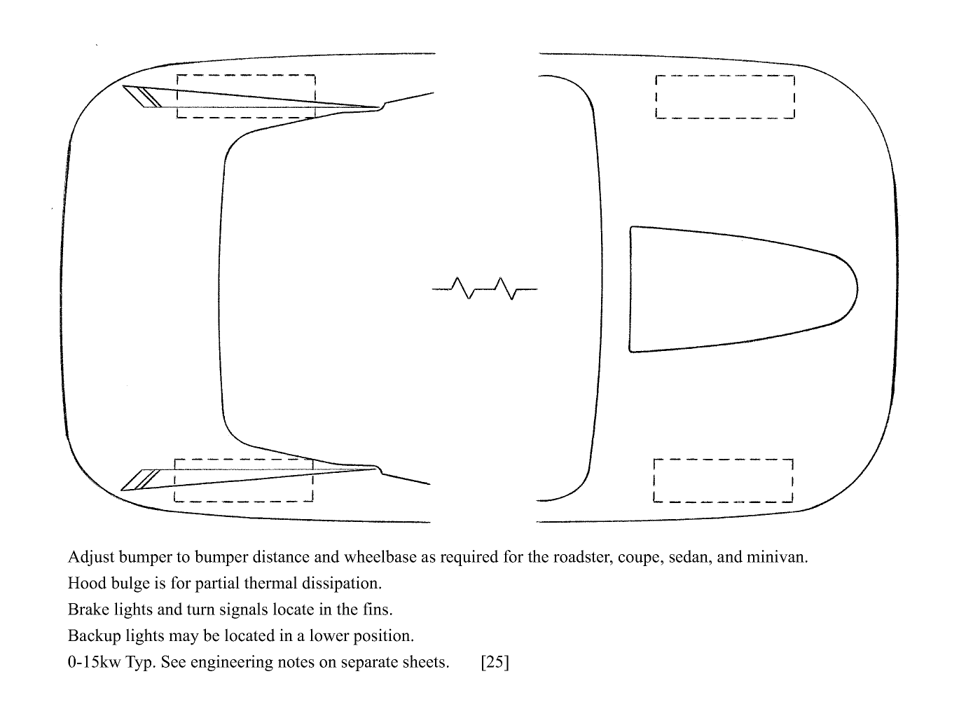

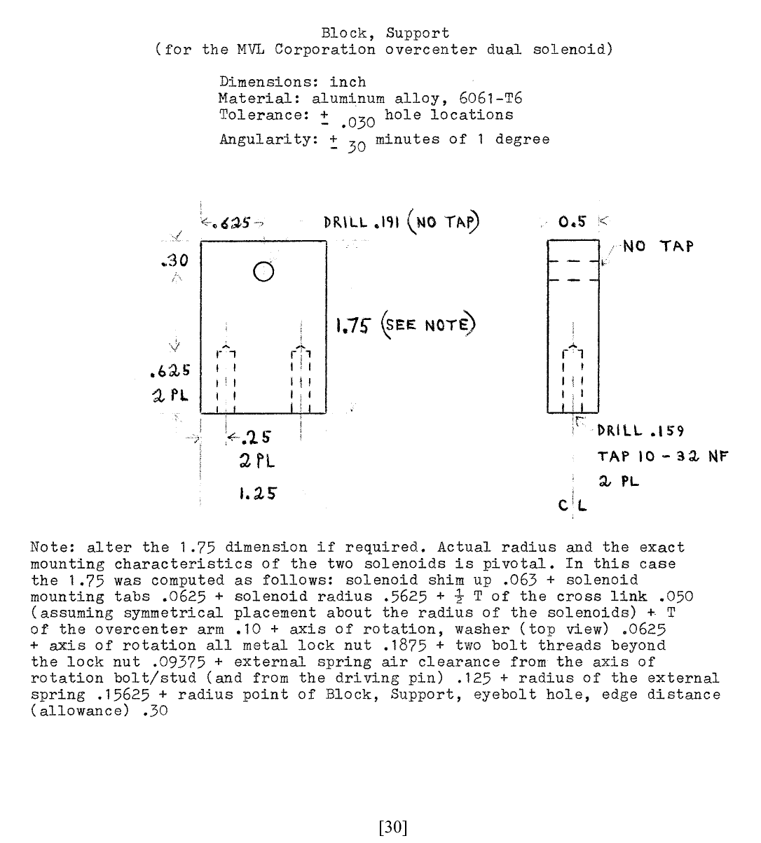

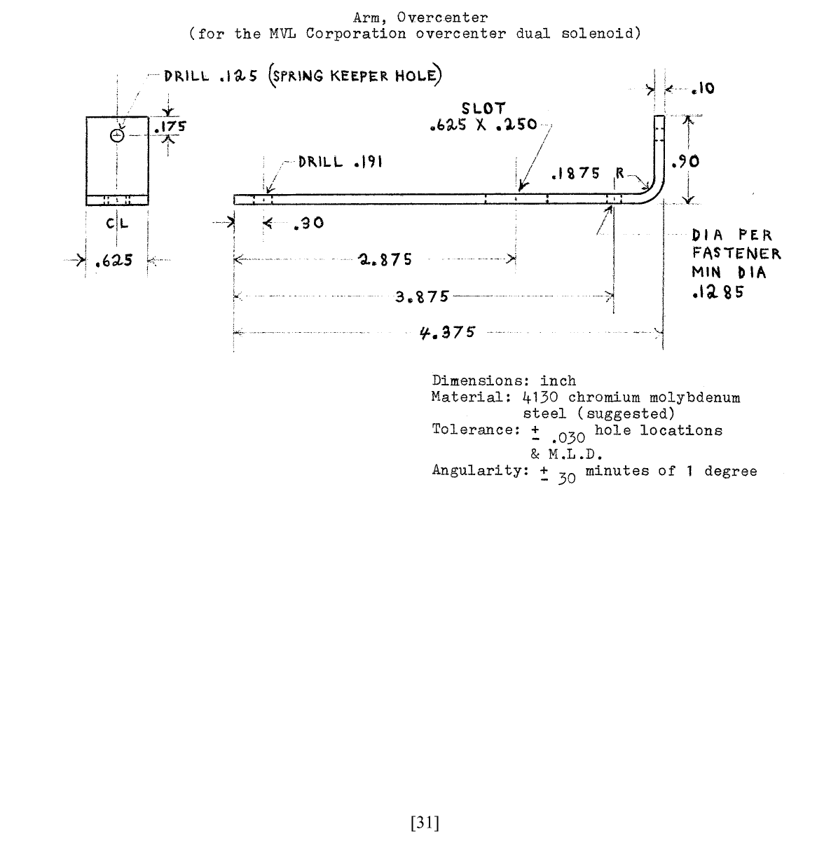

The direction of current flow through a schematic nonzener type diode is in the direction of its arrow like feature. Reference: Electricity and Electronics for Aerospace Vehicles, Second Edition, Northrop Institute of Technology, James L. McKinley—Ralph D. Bent—McGraw-Hill Book Company, copyright 1971—see page 78, figure 4.25—see also page 192, figure 9.22

See the electrical system schematic entitled “Vehicle, Electric, Interstate, Alpha” (MVL Corporation).

See the primary structure entitled “Vehicle, Electric, Interstate, Alpha, Primary Structure” (MVL Corporation).

Suggest that the front and rear bumpers (of the Primary Structure) be of rubber tire material (no treads).

License plates and lights should not be located in high profile impact zones.

The undersigned suggests that the hood and fenders swing up together, hinged at the front of the vehicle, a minimum of 95 degrees, and safety locked against the wind when in the full open position, for all models (roadster, coupe, sedan—stretched 2 feet for more backseat legroom, and more trunk space—and the minivan).

The undersigned suggests that all four models have tinted acrylic plastic roofs—beware of the expansion coefficient! Any mounting holes in the acrylic plastic panels must be oversized! There can be no (localized) compression loads on the acrylic plastic panels from screws, bolts, or nuts! Gasket seal the edges of the acrylic plastic panels. Padded roll bar×2 for the roadster, and padded roll bar×3 for the coupe, sedan, and minivan, if said vehicles have acrylic plastic roof panels.

The undersigned suggests rear wheel fairings on all four models—tab into slot, at the lower fore and aft installation points (first installation step—the two tabs in each case being on the fairing panel) and the upper area of each fairing panel being secured by three screws.

Two dimensional, or three dimensional markings on the outside of these four models, as “Limited,” “LE,” “FWD,” “6 Speed,” “Twin Motors,” “Electric,” “Electric Vehicle,” “emf,” “PIE,” “ionic,” “coulombic,” “joule,” “15 kw,” “E=mc²,” or any other such marks, are not permitted by the undersigned. A vehicle is meant to be a functional mechanized art form, not a billboard containing extraneous gibberish. A vehicle that has “Ultra Pleat” (trademark of MVL Corporation) battery plates of zinc silver, or cadmium silver, and sufficient enthalpy to run 550×5,280 feet at a steady (constant load) 60 miles per hour at 70 degrees Fahrenheit outside air temperature, with reliability, speaks for itself.

The production model names of “Nirubec” (with permission) for the roadster, “Esmerelda” (with permission) for the coupe, “Volare” (with permission from the estate of Dean Martin), for the stretched sedan, and “Paletin” (phonetic spelling—with permission—the Western series of half a century ago—“Have Gun, Will Travel”), for the minivan, are able to provide vehicle recognition for the four models—the names being carefully affixed to the rear of the vehicles. “Nirubec” and “Esmerelda” (phonetic spellings) are girls who lived next door to me—they have a brother named David. It is optional to affix the uppercase letters “MVL” to the front of the four models (Manufacturing Vehicular Leadership).

Purpose of the Tri Diode Resolver Module: the Tri Diode Resolver Module is designed to interface two opposing emf fields, and to provide a component of voltage (current) comparison, of these two emf fields. If the greater emf field comes in from the left side, the far right drain lead will have the lower voltage. If the greater emf field comes in from the right side, the far left drain lead will have the lower voltage. If both emf fields are approximately the same field strength, then all four drain leads will have approximately the same voltage. If a diode rectifier floats, then both emf fields will use the inboard drain that is adjacent to the floating diode rectifier, as a common drain, and the weaker emf field will also use its respective outboard drain lead, that is adjacent to said floating diode rectifier. Employ in the gas filled tube envelope atomic number 10, or atomic number 18, or a mixture of atomic number 36 and atomic number 18 (engineering discretion), or atomic number 54 (extreme engineering discretion). The two line in variable resistors are for initial module installation, calibration purposes, and are not cycled otherwise.

Spring Action Overcenter Dual Solenoid (normally open circuit, both cycle directions).

Said overcenter dual solenoid is (in each case) split core, without (in each case) an internal spring. A single external spring (omitted from the assembly drawing for the purpose of clarity) cycles the overcenter arm one direction, and then in the other direction (in conjunction with the two solenoids). Said assembly may be employed for switching functions, and the overcenter arm may be adapted for valve operations. Electrical switch contacts may be located at multiple elevations. The bridge contact clip may be secured to the overcenter arm directed towards the base plate for single elevation switch arrays, or the bridge contact clip may be secured to the overcenter arm directed away from the base plate for multiple elevation switch arrays. The bridge contact clip should have a slight swivel capability. Add additional terminal strips as required—secure as required. The terminal screws are to be insulated from each other (excluding the action of their own switch contacts). All screw threads 10-32 NF. Terminal screws may be ¼-28 NF (centerline to centerline minimum distance 0.75 of an inch). All electrical switch contacts to be minimum ¼ of an inch in diameter if round, or a minimum of 0.125 by 0.375 of an inch if rectangular. The undersigned recommends that the external spring have an outside diameter of 0.3125 of an inch (a spring of appropriate gauge with an outside diameter of 0.28125 of an inch is acceptable). The undersigned recommends pure pull tension required to separate the switch contacts 0.0625 of an inch to be 8 to 12 ounces (when field is collapsed).

Axis of rotation of the overcenter arm may be provided by a NAS 1103 bolt (National Aircraft Standard) in conjunction with a spacer (aluminum alloy, 6061-T6, hexagon stock) or a washer stack (washer stack, or spacer height approximately 0.738 of an inch) and a washer and an all metal lock nut (two bolt threads beyond the lock nut). The NAS 1103 bolt may be installed by applying a small amount of metal cement to the underside of the bolt head and pressing the bolt through the base plate hole provided for said bolt, hole diameter 0.1875 of an inch. The base plate may be of aluminum alloy, 6061-T6, 0.100 of an inch thick. Axial play of the overcenter arm at its axis of rotation to be 0.003 to 0.020 of an inch—lightly lubricate the pivot area. Radial play of the overcenter arm at its axis of rotation to be approximately 0.002 of an inch (axis of rotation hole in overcenter arm drill 0.191). The overcenter arm may be of 4130 chromium molybdenum steel, 0.100 of an inch thick. The slot of the overcenter arm is to be 0.250 of an inch wide (located on the centerline of the arm) and 0.625 of an inch in length, and longitudinally placed so that the driving pin of the cross link does not strike either end of the slot during full cycle events.

The cross link and its driving pin may be of 4130 chromium molybdenum steel, the cross link being 0.100 of an inch thick. The driving pin of the cross link is to have a diameter of 0.1875 of an inch and is to be pressed/welded to the cross link. The interface of the overcenter arm and the cross link and its driving pin are to be lightly lubricated. The cross link is to have a (slight) universal joint connection with the two solenoids.

The two solenoids may be secured using AN365 (Army and Navy or Air Force and Navy) lock nuts, torque drag plus 25 inch pounds of torque (10-32 NF—two bolt threads beyond the lock nuts). The distance between the overcenter arm and the base plate is influenced by the actual radius and the exact mounting characteristics of the two solenoids. The overcenter arm and the base plate should be essentially parallel to each other. The external spring should be in a plane that is parallel to the longer mold line dimension of the overcenter arm. The external spring must have an air clearance from the axis of rotation bolt/stud, and from the driving pin, that is at least 0.125 of an inch. The base plate mounting holes for the next higher assembly may be drilled number 16 or number 7, for use with number 8 diameter hardware, or for use with number 10 diameter hardware.

To cycle the spring action overcenter dual solenoid (either cycle direction) employ (in the case of “Vehicle, Electric, Interstate, Alpha”) 48 volts direct current to the appropriate solenoid winding for a duration of 2 seconds, using a timer.

See the assembly drawing for the “Spring Action Overcenter Dual Solenoid,” and the engineering drawings, “Block, Support” and “Arm, Overcenter.”

### Electronic Governor

Electronic governor of the cruise control (proposed): assign 60,000 memory units to the electronic governor (the millisecond standard×60)—each 1 R.P.M. is to occupy a memory unit—reduce the 270 MHz intermediate frequency to the apparent number of 270—always subtract the vehicle's actual R.P.M. number (which will be generated by a spinning permanent magnet located inside of the vehicle's transmission/transaxle) from the number 270, even if the vehicle's actual R.P.M. number is greater than the number 270. If at 60 M.P.H. the permanent magnet (per an assumed gear ratio) cuts across its conductor 1,800 times in one minute, then the memory unit containing negative 1530 would be used to lock the vehicle's velocity at 60 M.P.H., if the driver had instructed 60 M.P.H. If at 65 M.P.H. the permanent magnet cuts across its conductor 1,950 times in one minute, then the memory unit containing negative 1,680 would be used to lock the vehicle's velocity at 65 M.P.H., if the driver had instructed 65 M.P.H. If at 70 M.P.H. the permanent magnet cuts across its conductor 2,100 times in one minute, then the memory unit containing negative 1830 would be used to lock the vehicle's velocity at 70 M.P.H., if the driver had instructed 70 M.P.H.

Load changes: if the cruise control is engaged, the microprocessor directs 48 V.D.C. to the linear actuator, for (the purpose of) velocity correction.

Cruise control velocity tolerance: plus or minus 1 M.P.H.—level ground, and gentle slopes.

Cruise control automatic brake application(s) down long hills—no.

### Radio Detection and Ranging

Cruise control, when engaged by the driver, automatic brake application, factory set range 25 feet to 100 feet, driver adjustable within said range—application of the sum frequency per radio detection and ranging, per automatic intrinsic type-A scan, per the given signal out and back travel time, each 1 linear foot, 0.0020374 microsecond, for the sake of front end/rear end automatic collision avoidance—engineering discretion.

A radio detection and ranging, pulse duration, of 0.250 microsecond (output) will not fit in between the paraboloidal reflector and a target that is 25 feet, to 100 feet, from the paraboloidal reflector, assuming that the pulse signal is not meant to distort/compress itself as a result of the signal pulse (output) still occurring even though the signal pulse already has a partial reflected return to the paraboloidal reflector.

The signal out and return time when the target (vehicle) is 25 feet away is 0.0509350 microsecond. The signal out and return time when the target (vehicle) is 100 feet away is 0.203740 microsecond.

### REFERENCE TO THE DRAWINGS

“The patent or application file contains at least one drawing executed in color. Copies of this patent or patent application publication with color drawing(s) will be provided by the Office upon request and payment of the necessary fee.”

Drawing 1/7 of application Ser. No. 13/066,063 is an orthographic projection, top view, of a secondary cell with the engineering mandate of no nonsense enthalpy expansion and mass production compliance that employs, without deviation, a uniform pleated plates/grids pitch standard that remains centerline compliant along the pleat generation axis, and without deviation, a uniform plates/grids intermesh standard (with the opposite polarity plates/grids) for secondary cells of 48 volts, 24 volts, and 12 volts, regardless of the type of grid alloy, type of active materials, and type of electrolyte.

Drawing 2/7 of application Ser. No. 13/066,063, entitled “Vehicle, Electric, Interstate, Alpha,” is the practical application of secondary cells that have pleated plates/grids.

Drawing 3/7 of application Ser. No. 13/066,063, entitled “Vehicle, Electric, Interstate, Alpha, Primary Structure,” is a potential incorporation into drawing 2/7.

Drawing 4/7 of application Ser. No. 13/066,063, entitled “Tri Diode Resolver Module,” is an electronic ratiometer, and is a potential incorporation into drawing 2/7.

Drawing 5/7 of application Ser. No. 13/066,063, entitled “Spring Action Overcenter Dual Solenoid,” is for electrical load switching and is represented in drawing 2/7.

Drawing 6/7 of application Ser. No. 13/066,063, entitled “Block, Support,” is an attribute of drawing 5/7.

Drawing 7/7 of application Ser. No. 13/066,063, entitled “Arm, Overcenter,” is an attribute of drawing 5/7.

### Key To “Ultra Pleat” Secondary Cell

### Inventor—Michael Vincent Latino

### United States Patent & Trademark Office application Ser. No. 13/066,063

1—Secondary cell (storage battery) battery housing

### 2—Separator

3—Electrolyte reservoir
4—Negative plate/grid
5—Positive plate/grid

### Key To Vehicle, Electric, Interstate, Alpha

### Inventor—Michael Vincent Latino

### United States Patent & Trademark Office application Ser. No. 13/066,063

### Key To Spring Action Overcenter Dual Solenoid

### Inventor—Michael Vincent Latino

### United States Patent & Trademark Office application Ser. No. 13/066,063

6—Base plate

### 7—Solenoid

8—Cross link

### 9—Driving pin

10—Arm, overcenter
11—Bridge contact clip
12—Switch contacts
13—Spring keeper, and spring tension adjustment
14—Block, support
15—Terminal block (terminal strip)

1. Wherein the improvement comprises (application Ser. No. 13/066,063) a component of enthalpy expansion of secondary cells through the instrumentality of pleated battery plates/grids, that are centerline compliant (orthographic projection, top view)—
and pleated battery plates/grids (that are) of uniform pitch standard, without deviation—
and, wherein the improvement comprises (battery) plate/grid peak to trough alignment during assembly of the cell elements, without deviation—
for 48 volts, 24 volts, and 12 volts secondary cells—
regardless of the type of (battery) grid alloy, the type of (battery) active materials, and regardless of the type of (battery) electrolyte.
Wherein the improvement comprises (application Ser. No. 13/066,063) the use of a pair of (machined) matching dies, of the same geometric standard, that are both male and female, and are both of medium carbon steel, that both have peaks and troughs of modest consistent radius, and that both provide a consistent 100 percent to 110 percent (the same value for a given die set) surface area gain in the direction of the pleat (generation) axis, characterized by a consistent, uniform pleat pitch standard, and both matching dies are (to be) sized (so as) to fully press/form a prepunched raw material battery plate/grid in a single press operation, and the die set is employed in an intermeshed, secured capacity, and both matching dies, on their reverse side, are (to be) flanged to permit a safe, reliable attachment—
attachment to a hydromechanical brake—
or (in the alternative) flanged to permit a safe, reliable attachment to a drop hammer.
Wherein the improvement comprises (application Ser. No. 13/066,063) “Vehicle, Electric, Interstate, Alpha,” which has (when properly manufactured) a dual electric induction split phase motor (system) and a dual overrunning clutch propulsion system, that drives into a common autotrans, and thus (the improvement) a no yaw bias in the event of one electric induction motor dropping out.
Wherein the improvement comprises “Vehicle, Electric, Interstate, Alpha,” that utilizes (dependent upon claim number [0001], of application Ser. No. 13/066,063) a secondary cell system of uniform pleated battery plates/grids, to (the improvement)—
extend the range of the pure electric automotive vehicle—
to eliminate the apparent output of carbon monoxide from applicable automotive vehicles—
to reduce the risk of differential pressure (impetus) shrapnel output in the event of an accident—
and to reduce the risk of a fireball in the event of an accident.
